(19) United States
(12) Patent Application Publication
(10) Pub. No.: US 2004/0131926 A1
(43) Pub. Date: Jul. 8, 2004

(54) Electric battery having autonomous watering and acid mixing systems

(76) Inventor: William E. M. Jones, Freeport (BS)

Correspondence Address: SYNNESTVEDT & LECHNER, LLP, 2600 ARAMARK TOWER, 1101 MARKET STREET, PHILADELPHIA, PA, 191072950

(21) Appl. No.: 10/694,276

(22) Filed: Oct. 27, 2003

Related U.S. Application Data
(60) Provisional application No. 60/421,433, filed on Oct. 25, 2002.

(51) Int. Cl. H01M 2/36

(52) U.S. Cl. 429/64; 429/74

(57) ABSTRACT

A liquid electrolyte battery is disclosed having autonomous watering and electrolyte mixing systems. Watering is effected through a fluid conduit and a valve system mounted on the battery providing fluid communication and flow control between a fluid source and the battery cells. Mixing of the electrolyte is effected by pumping air into the battery cells to prevent acid stratification during charging using an air conduit and air pump mounted on the battery. The fluid conduit provides fluid communication between the air pump and the cells. A controller mounted on the battery receives input signals from various sensors indicative of electrolyte level and charging status and controls the valve system and the air pump to effect watering and electrolyte mixing. A protective cover is mounted on the battery to restrict access to the controller and the air pump.

### RELATED APPLICATION

This application is based on and claims the benefit of U.S. Provisional Application No. 60/421,433, filed Oct. 25, 2002, which is hereby incorporated by reference herein.

### FIELD OF THE INVENTION

The invention concerns electric batteries having aqueous electrolytes and systems for automatically replenishing water to the battery and mixing the electrolyte during battery charging to prevent acid stratification.

### BACKGROUND OF THE INVENTION

Electrical batteries that have aqueous electrolytes and see heavy duty industrial use, such as lead-acid batteries powering fork-lift trucks, consume water during charging and, therefore, require periodic replenishing of the water constituent of the electrolyte in each of the battery's cells.

Watering of the cells in a battery may be performed manually; a technician visually inspects the water level in each cell of a battery and adds water to any cells which show a low level of electrolyte. For large batteries with many cells, this can be a tedious, error prone process, thus, single point watering systems were developed. Single point watering systems may comprise, for example, simple float valves positioned in each cell, the cells being linked together by a common water supply tube which feeds water to the cells through the float valves. When watering is required, the water supply tube is connected to a water reservoir, water flows from the reservoir to the cells and the float valves close to cut off the flow of water once their respective cells are filled. Watering systems having increased automation have evolved using automatic controls thereby allowing a technician simply to connect the watering system to a battery and leave the system unattended. In such automatic systems, the equipment and controls necessary for automatic watering are usually integrated with a specially designed battery charger. This configuration is disadvantageous because the batteries must now depend on a specific charger for automatic watering. Thus, to obtain an automatic watering system one must purchase a new charger which represents a significant capital expenditure.

When a lead-acid battery is discharged, its acid electrolyte will become depleted as the plates in the cells become sulfated and water is formed within the cells by the chemical reactions associated with discharge. On recharge, concentrated acid is released back from the plates and, having a higher specific gravity than the water, sinks to the bottom of the cells. This concentrated acid, if permitted to remain stratified, can damage the bottoms of the plates. It is recognized as desirable, therefore, to have some method for mixing the acid with the water in the cells during the charging to prevent acid stratification.

One method of preventing acid stratification is known as “air mixing”. In this method, air is pumped during charging into each cell through tubes, each having an outlet in the lower regions of the cells. The air pumped into each cell forms bubbles which rise and thereby mix the electrolyte with little loss of water compared with overcharging the cells. In the past, to effect automatic air mixing during charging, an air pump and a control system have been mounted in or on the battery charger. The air pump, under control of the control system, delivers air to the battery cells via a tubing system which distributes the air to each cell at the appropriate time during charging. The automatic air mixing system is associated with the charger, thus, leading to a similar disadvantage for the automatic mixing system as experienced with the automatic watering system.

There is clearly a need for automatic watering and air mixing systems which are associated with the electric battery and not with the battery charger, thus, making routine servicing of the battery independent of the type of charger being used.

### SUMMARY AND OBJECTS OF THE INVENTION

The invention concerns an electric battery having autonomous watering and mixing systems. The battery comprises a plurality of aqueous electrolyte cells and is connectable to a water source for replenishing water in the cells. The battery includes a conduit fixed to the battery which is connectable to the water source for receiving water therefrom, and which preferably includes a coupling for easy connection to the water source. The conduit is also in fluid communication with each of the cells. A valve system associated with the conduit and cells controls the flow of water to the cells.

In one embodiment, the valve system comprises a conduit valve positioned in the conduit between the coupling and the cells for controlling fluid flow therebetween. A respective cell valve is positioned between the conduit and each of the cells for controlling fluid flow from the conduit into each of the cells. An electrolyte level sensor, capable of generating signals indicative of the amount of electrolyte present, is positioned in at least one of the cells. The one cell having the electrolyte level sensor is representative of all of the battery cells. A controller is mounted in or on the battery, the controller being in communication with the electrolyte level sensor and the conduit valve. The controller opens the conduit valve in response to the signals from the electrolyte level sensor indicative of a deficient amount of electrolyte in the cell. Water flows through the conduit to each of the cells. As each cell fills with water to the desired level, each respective cell valve closes, stopping flow of water to the cell. Preferably, the controller is programmed to delay closing the conduit valve for a predetermined period of time. This ensures that all of the cells receive the necessary water. The controller is also preferably programmed to delay opening of the conduit valve until the voltage in the cells reaches a predetermined value during charging, for example, a voltage which correlates with the maximum acid level in the cells caused by gas bubbles accumulated in the cells as a result of charging. This method, which is already in general use with conventional, charger-based watering systems, will help prevent the cells from being overfilled during watering.

In another embodiment, the coupling which engages the fitting from the water source has an automatic disengage feature. The automatic disengage feature comprises a biasing member positioned between the coupling and the fitting for ejecting the fitting away from and out of engagement with the coupling, and a latch movable between a first position engaging and holding the fitting in engagement with the coupling against the biasing member, and a second position releasing the fitting from engagement with the coupling. The latch is actuated between the first and second positions by the controller thereby permitting automatic disconnect of the fitting from the coupling.

In another embodiment, the battery according to the invention has, in addition to a watering system, an air mixing system. The air mixing system includes a charging sensor capable of generating a signal indicating when the battery is being charged. The charging sensor may be an algorithm on the controller or a distinct physical sensor in or on the battery. The charging sensor is in communication with the controller. An air pump is mounted in or on the battery and is in fluid communication with an air conduit in fluid communication with each cell. The air conduit is separate from the aforementioned water conduit for watering the cells but the two systems preferably share the same electronic controller.

The controller activates the air pump in response to signals from the charging sensor indicating that the battery is being charged, the air pump pumping air into the cells to promote mixing of the electrolyte and, thereby, prevent acid stratification during charging.

Other embodiments of the battery comprise a plurality of air pumps in fluid communication with the conduit, the controller being in communication with all of the air pumps and activating them during charging of the battery, the air pumps pumping air into the cells to promote mixing of the electrolyte and, thereby, prevent acid stratification during charging.

When multiple pumps are present, they can be dedicated to pump air into different groups of cells. Such a battery comprises a plurality of first cells holding the electrolyte, a first air pump and a first conduit in fluid communication with the first air pump. The first conduit is in fluid communication with each of the first cells. The battery also has a plurality of second cells holding the electrolyte, a second air pump and a second conduit in fluid communication with the second air pump. The second conduit is in fluid communication with each of the second cells. The battery also has a sensor capable of generating signals indicating when the battery is being charged. A controller mounted in or on the battery is in communication with the sensor and the first and second air pumps, the controller activating the air pumps in response to the signals from the sensor indicating that the battery is being charged, the air pump pumping air into the first and second cells to promote mixing of the electrolyte and, thereby, prevent acid stratification during charging.

A bridge conduit may also be mounted on the battery to provide fluid communication between the first and the second conduits. The bridge conduit allows one of the first and second pumps to pump air into both of the first and the second cells during charging of the battery, thereby providing redundancy in the event of an air pump failure.

For multiple pump embodiments, the controller may also include a pump sensor capable of generating a signal indicating failure of any of the pumps and an alarm in communication with the controller, the alarm being responsive to the pump sensor signal and adapted to generate an alarm signal indicative of the failure.

In all of the embodiments, it is preferred that the battery have a cover positioned over the electronic and electrical components on the battery including the controller, the conduit valve, the cell valves and the air pump or pumps. The cover is preferably locked or bolted down on the battery to restrict access to the components and prevent damage to them. A steel cover is preferred to contain any hydrogen explosion.

The invention also includes a method of mixing electrolyte in cells of an electric battery having a liquid electrolyte to prevent stratification. The method comprises the steps of:

(A) sensing when the battery is being charged;

(B) pumping air into the electrolyte within the cells during charging, either continuously or intermittently, using one or more air pumps mounted on the battery in fluid communication with the cells through a conduit fixed to the battery;

(C) sensing if one of the air pumps fails to operate; and

(D) compensating for a failure of one of the pumps by using another of the pumps.

The invention further encompasses a method of replenishing fluid to cells of an electric battery having a liquid electrolyte. The method comprises the steps of:

(A) connecting the battery to a fluid source;

(B) sensing when the electrolyte in the battery is low;

(C) allowing fluid to flow from the fluid source to the cells through a conduit fixed to the battery;

(D) sensing when said electrolyte in said battery is adequate; and

(E) halting flow of said fluid to said cells.

It is an object of the invention to provide a battery having an automatic watering system independent of the battery's charger.

It is another object of the invention to provide a battery having an automatic air mixing system independent of the charger to prevent acid stratification during charging.

It is another object of the invention to provide a battery having both automatic watering and air mixing systems as part of the battery, preferably with a common controller.

It is yet another object of the invention to provide a battery having multiple air pumps as part of the air mixing system.

It is again another object of the invention to provide a battery wherein the multiple air pumps pump air into different cells.

It is yet again another object of the invention to provide a battery wherein the multiple air pumps are interconnected so as to provide redundancy and be able to pump air into several groups of cells.

It is still another object of the invention to provide a method of air mixing a battery electrolyte during charging using multiple air pumps such that a pump failure is signaled and the remaining pumps are operated at increased throughput or for a longer duration so as to compensate for the reduced air flow caused by the failure of one or more pumps.

These and other objects and advantages of the invention will become apparent upon consideration of the drawings and detailed description of preferred embodiments of the invention.

### BRIEF DESCRIPTION OF THE DRAWINGS

FIG. 1 is a schematic representation of an autonomous battery according to the invention;

FIG. 2 is a schematic representation of another embodiment of an autonomous battery utilizing multiple pumps;

FIG. 3 is a schematic representation of still another embodiment of an autonomous battery with redundant pumps;

FIG. 4 is a perspective view of an autonomous battery according to the invention.

### DETAILED DESCRIPTION OF THE PREFERRED EMBODIMENTS

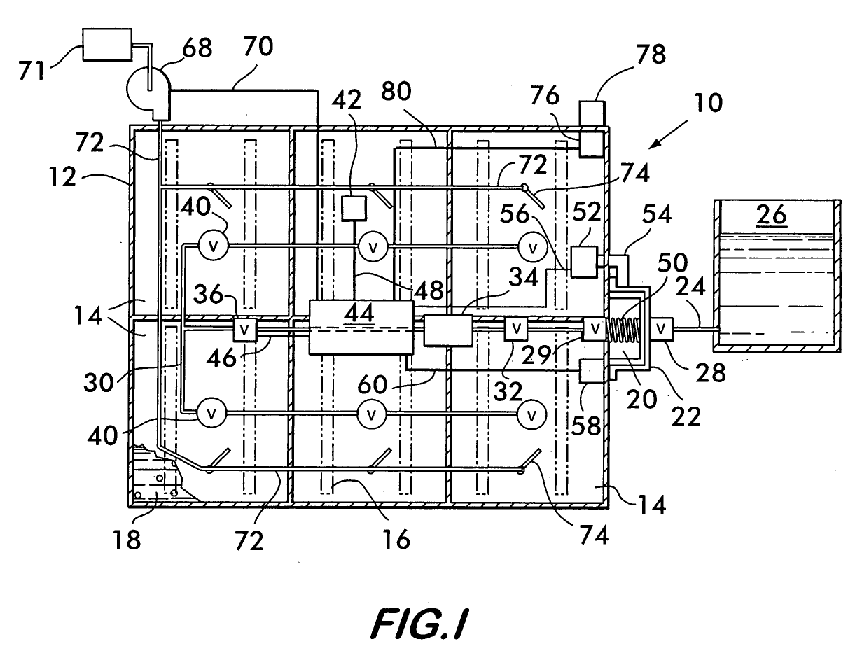

FIG. 1 is a schematic view of an electric battery 10 according to the invention. Battery 10 comprises a casing 12 divided into a plurality of cells 14, the cells housing battery plates 16 immersed in a liquid electrolyte solution 18. By way of example, battery 10 is a lead-acid battery because such batteries require water replenishment and suffer from acid stratification upon charging, and both of these aspects are addressed by the invention. It is understood, however, that the invention is not limited for use only with lead-acid batteries.

Autonomous Watering System

FIG. 1 illustrates a battery 10 according to the invention having an autonomous watering system. Battery 10 has a coupling 20 preferably mounted on its casing 12, the coupling 20 being compatible with a fitting 22 coupled to a hose 24 in fluid communication with a water source in the form of a reservoir 26. To replenish the cells 14 with water, fitting 22 is engaged with coupling 20, thereby linking the reservoir 26 to the battery 10. Fitting 22 preferably includes a shut-off valve 28 that opens when the fitting 22 is engaged with coupling 20, the valve being otherwise closed and preventing water flow from reservoir 26. To prevent back flow of water out of battery 10 when the fitting 22 and coupling 20 are disengaged, the coupling may be equipped with a similar shut-off valve 29 which is normally closed but opens upon engagement of the fitting and coupling. Such valve combinations are known as water stop valves that are closed when the couplings of which they are a part are not engaged, but which open upon mutual engagement of the couplings.

Coupling 20 is in fluid communication with a conduit 30 mounted in or on the battery 10. In lieu of a water stop valve 29 in coupling 20, conduit 30 may have a check valve 32 downstream of coupling 20 to prevent back flow of water through the coupling. Conduit 30 also has a filter 34 to remove particulate matter from the water flowing through it.

A valve system is operatively associated with conduit 30 for controlling the flow of water from reservoir 26 through the conduit and to the cells 14. In the preferred embodiment shown in FIG. 1, the valve system comprises an electrically operated conduit valve 36, preferably a solenoid valve powered by the battery 10 and positioned in conduit 30 to control the flow of water from the reservoir to the cells 14. Downstream of the conduit valve 36 the conduit 30 is in fluid communication with each of the cells 14. Each cell 14 has a cell valve 40 that controls the flow of water from conduit 30 to the particular cell 14 with which it is associated. For the battery embodiment 10 having the conduit valve 36 as shown in FIG. 1, cell valves 40 preferably comprise valves having a valve closing member responsive to the level of fluid in the cell to effect opening and closing of the valve. Automatically closing mechanical valves, such as float valves or injector valves, are an example of such valves.

At least one cell 14 has an electrolyte level sensor 42 adapted for sensing the amount of electrolyte in the cell and generating a signal indicative of that amount. The one cell is representative of all of the cells in the battery and serves as an indicator of the electrolyte level in the battery. Electrolyte sensor 42 is preferably powered by the battery 10, may be of any practical design and could, for example, be similar to the sensors disclosed in U.S. Pat. No. 5,936,382 which is hereby incorporated by reference herein.

A controller 44 is mounted on or in battery 10. Controller 44 may comprise a group of discrete electronic, electro-mechanical and/or mechanical components and/or an integrated circuit such as a microprocessor. The controller 44 is preferably powered by the battery 10 itself and is capable of executing pre-programmed or hard-wired algorithms and/or has resident software providing programmed algorithms controlling the operation of the battery watering function. Controller 44 is in communication with conduit valve 36 and electrolyte sensor 42 over respective communication links 46 and 48. Controller 44 controls the opening and closing of conduit valve 36 in response to signals from the electrolyte level sensor 42 as described below.

As battery 10 is alternately charged and discharged during its working life, water is depleted from the cells. The water must be periodically replenished. This is done substantially automatically by a technician engaging fitting 22 with coupling 20 on the battery 10. Engagement of the fitting with the coupling opens the water stop valves 28 and 29 in fitting 22 and coupling 20, allowing water to flow through coupling 20 and into conduit 30, passing though check valve 32 (if present) and filter 34 to conduit valve 36. Conduit valve 36 is preferably normally closed. If the electrolyte level is low, electrolyte level sensor 42 generates a signal indicative of this condition and the signal is relayed over communication link 48 to controller 44. Controller 44 then uses communication link 46 to open conduit valve 36. Water flows through the conduit valve 36 to the cells 14 through the remainder of conduit 30.

In this example embodiment, cell valves 40, which regulate flow to each cell 14, comprise automatically closing mechanical valves such as float valves. Mechanical valves are advantageous because their operation depends directly upon the electrolyte level within the cells. Thus, each cell 14 that requires electrolyte will have an open valve 40, and water will be allowed to flow into each cell 14 with a low electrolyte condition. One advantage to the valve system comprising the conduit valve 36 and mechanical valves 40 is that it can handle a battery wherein different cells consume water at different rates without the need for direct control of the cell valves. As each cell 14 is topped off, its mechanical valve 40 automatically closes, and water flow ceases to the cell. To ensure that all of the cells 14 receive adequate water, the controller 44 can delay closing the conduit valve 36 for a predetermined period of time (e.g., a few minutes). The fitting 22 may then be decoupled from coupling 20.

It may be desirable to have the coupling 20 disengage itself automatically from fitting 22 at the completion of the watering process. This is accomplished by providing a biasing member 50 positioned between the coupling 20 and fitting 22 for biasing the fitting away from the coupling, and a latch 52 for temporarily holding the fitting in engagement with the coupling against the force of the biasing member. Biasing member 50 is preferably a spring, and latch 52 preferably comprises a solenoid actuated dog 54 powered by the battery 10 and movable between a first position engaging and holding the fitting 22 in engagement with the coupling 20 against the biasing force of biasing member 50, and a second position disengaged from fitting 22, thereby allowing biasing member 50 to eject the fitting 22 from engagement with the coupling 20. Latch 50 is under the control of controller 44 and communicates with it through a communication link 56. A fitting sensor 58 is preferably positioned proximate to coupling 20. Fitting sensor 58 may, for example, be a limit switch coupled to controller 44 by a communication link 60. Engagement of fitting 22 with coupling 20 is sensed by the fitting sensor 58 and signaled to the controller over link 60. The controller 44 moves the latch 52 into the first position holding the fitting 22 to the coupling 20. After completion of battery watering, as signaled to the controller 44 by the electrolyte level sensor 42, the controller 44 moves the latch to the second position releasing fitting 22. Biasing member 50 pushes the fitting 22 away from coupling 20, disengaging the fitting from the coupling and, thus, providing a positive and visible signal that battery watering is complete. Automatic ejection of the fitting 22 from coupling 20 provides the added advantage of preventing damage to the fitting 22, coupling 20 and battery casing 12 which occurs when technicians, upon completion of watering, move the battery away from the reservoir 26 while hose 24 is still attached.

Autonomous Air Mixing System

Battery 10, shown in FIG. 1, also comprises an autonomous air mixing system. The air mixing system is applicable to lead-acid type batteries that are subject to acid stratification during charging.

The air mixing system according to the invention comprises an air pump 68 mounted in or on the battery 10. The air pump is preferably electrically powered by the battery itself and is under the command of controller 44, linked thereto by a communication link 70. Air pump 68 draws ambient air in through a filter 71 and forces the air under pressure into an air conduit 72. Air conduit 72 is in fluid communication with each cell 14. A charging sensor 76 is also mounted in or on battery 10, the charging sensor being capable of generating a signal indicating that the battery is being charged, and communicating this signal to the controller, for example, over a communication link 80. Examples of various types of charging sensors are provided below.

In response to a signal from the charging sensor 76 indicating that battery 10 is being charged, the controller 44 switches air pump 68 on, and air is pumped through air conduit 72 and into each cell 14. For effective mixing of the electrolyte, branch air conduits 74 extend from air conduit 72 down to the lower regions of the cell 14, preferably level with the bottom of the plates 16. Air pumped into the cells 14 is thus forced to bubble up through the electrolyte, causing convection currents which mix the more concentrated acid layers which tend to form at the bottoms of the cells 14 with the less concentrated acid at the tops of the cells. This ensures that electrolyte mixing occurs between the regions of each cell having the highest acid concentration (the bottom) and the lowest (the top).

Signals from the charging sensor 76 are used by the controller 44, which preferably operates according to an algorithm to control the air mixing as follows. The controller 44 is powered by the battery 10, and is thus connected across a number of battery cells 14. The controller is thus subjected to the battery voltage fluctuations as it is discharged and charged. The controller 44 continuously monitors the voltage-per-cell of the battery 10 across the same leads that provide power to it. When charging begins, the voltage rises, and when the voltage exceeds a first predetermined value of volts per cell (e.g., 2.15 volts per cell), the controller determines that charging has commenced. The controller then switches the air pump 68 on and off at defined intervals according to the algorithm to provide maximum mixing of the electrolyte 18 within cells 14 with the fewest pump run hours. For example, an effective cycle is for the air pump 68 to run for 2 minutes during every 30 minutes of charging. Continuous running of the air pump 68 does not significantly improve the homogeneity of the electrolyte and has the disadvantage of greatly reducing the life of the air pump motors, particularly if these are small dc brush motors.

The flow of mixing air to the cells 14 continues at intervals as determined by the algorithm until the battery voltage reaches a second predetermined voltage (e.g., 2.35 volts per cell) higher than the first predetermined voltage that signaled charging initiation. From this second voltage level, the controller 44 determines that normal gassing and mixing has commenced within the cells 14 and that there in no further need for air mixing. However, the controller continues to operate the air pump 68 but only for short pulses at intervals. This action eliminates the possibility of lower density electrolyte left in the branch conduits 74 being forced upward into the conduit by differential pressure created by the increasing density electrolyte in each cell due to continued charging. A check valve located in each branch conduit 74 can serve the same purpose as can a single check valve in the main air conduit 72.

As a result of the charger shutting off, the battery voltage drops through a third predetermined value (e.g. 2.30 volts per cell) and again down further to a fourth predetermined value (e.g. 2.00 volts per cell) for a sufficient time period. From these voltage changes, and in accordance with the algorithm, the controller 44 determines that charging is complete. The controller 44 then switches pump 68 off. The controller 44 then resets and reverts to the status of continuously monitoring the voltage of the battery 10 to determine when the next charging cycle has commenced. This is a preferred algorithm but several other, similar algorithms are possible to control the air pumps.

Other embodiments of the charging sensor are also feasible. For example, the charging sensor 76 may be a limit switch that is mounted near a battery terminal 78 and senses, by contact with a charging cable or coupling, when the terminal 78 of battery 10 is connected to the charger. In response to contact with the coupling, the limit switch generates a signal that is communicated to the controller 44 over communication link 80, indicating charging. Alternately, sensor 76 may be a Hall Effect device which senses current flowing to the battery by the presence of the induced magnetic field surrounding the current. The Hall Effect device generates a signal in response to the magnetic field and communicates it to the controller to indicate charging of battery 10. A common shunt could also be used in the charging circuit whereby a voltage rise across the shunt is communicated to the controller indicating charging of the battery 10.

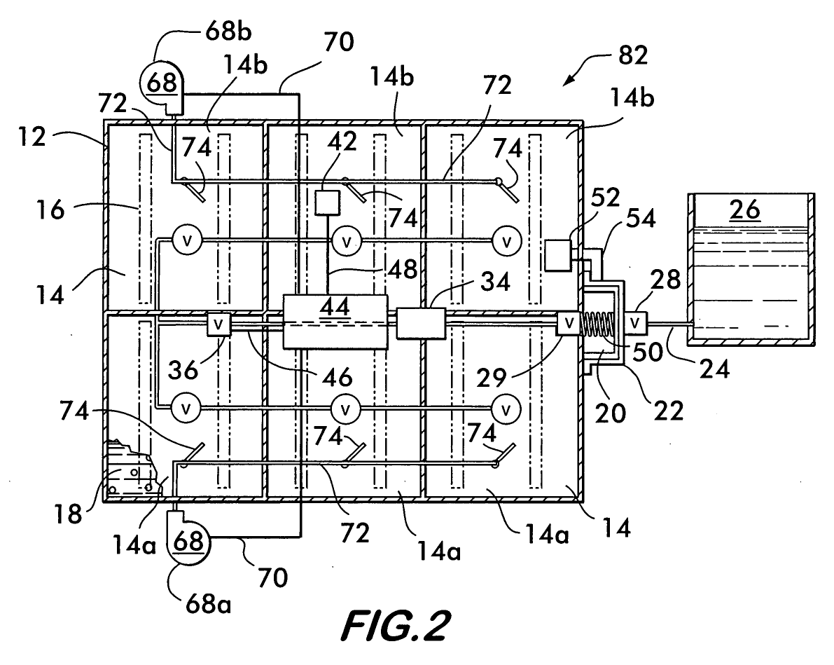

FIG. 2 shows an alternate embodiment of a battery 82 having an air mixing system using more than one air pump 68. Multiple pumps 68 are mounted in or on the battery 10 and are under the command of controller 44 as described above. When using multiple air pumps, it is advantageous to split their duties between different groups of cells 14. Thus, one pump, 68a, pumps air into a group of cells 14a, while another pump, 68b, is dedicated to a group of cells 14b. When multiple pumps are used in this manner, the conduit runs are not as long, and the commensurate pressure drop throughout the conduits is smaller than if one long conduit connects all cells. This ensures more uniform air distribution to all cells, preventing air starvation and poor mixing in cells far from the pump. The division of labor among multiple pumps also allows smaller pumps to be used that are easier to integrate into the battery 82.

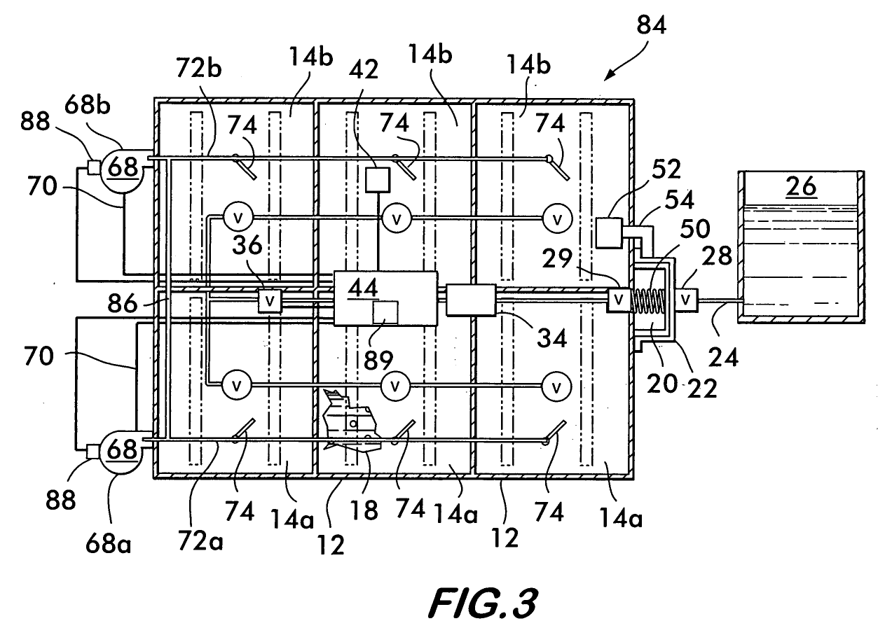

As illustrated in the battery 84 shown in FIG. 3, multiple pumps 68a and 68b may also be used to provide redundancy to the air mixing system by linking the air conduits 72a and 72b with a bridge conduit 86. In this manner, both pumps 68a and 68b supply air to both groups of cells 14a and 14b. Mixing will, thus, occur in both groups of cells during charging in the event that one of the pumps fails. In the event of an air pump failure, it is advantageous to have a pump failure sensor 88 in communication with the controller 44, the pump failure sensor generating a signal indicative of a non-operational pump that is received by the controller 44. Upon receipt of such a signal, the controller 44 may activate an alarm 89 to alert the technician of a pump failure. The pump failure sensor may detect pump failure in one of many different ways, for example, by sensing a voltage drop in the circuit supplying power to the air pumps. The alarm signal may also be effected in one of many ways, for example, an auditory alarm or a visual alarm such as a light on the battery which lights or fails to light when a pump is non-operational.

Further upon receipt of the pump failure signal the controller 44 may operate the remaining pump or pumps at a higher pressure or higher volume throughput, or longer duration to make up for the lack of pumping capacity occasioned by the failure of one or more pumps.

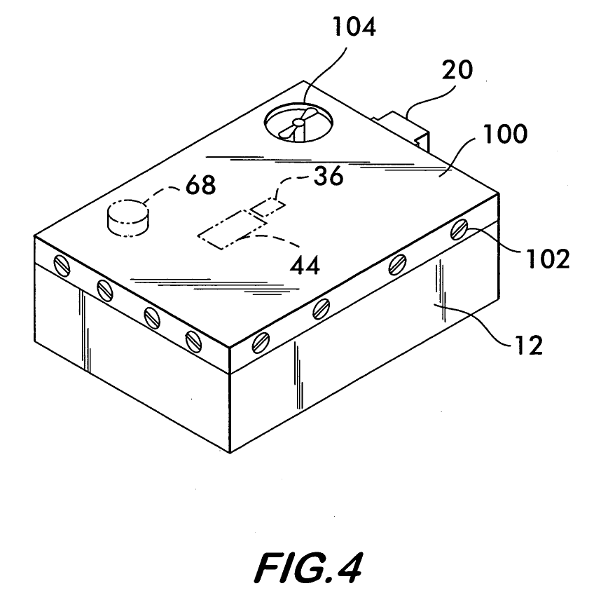

Preferably, all of the battery embodiments according to the invention include a ventilated cover 100 attached to casing 12 as shown in FIG. 4. Cover 100 is preferably steel and is securely attached or otherwise locked to the battery using, for example, fasteners 102 to restrict access to the various system components such as the controller 44, the air pump or pumps 68 and the conduit valve 36 which are protected under the cover. The cover 100, thus, prevents damage to and tampering with the components. Steel is preferred to contain any hydrogen explosion that should occur, but the cover is properly vented to prevent hydrogen gas build-up and may thus have ventilation fans 104 run by explosion proof motors.

What is claimed is:

1. An electric battery having a plurality of aqueous electrolyte cells, said battery being connectable to a fluid source for replenishing fluid in said cells, said battery comprising:
a fluid conduit fixed to said battery and capable of being connected in fluid communication with said fluid source, said fluid conduit being in fluid communication with said cells;
a valve system operatively associated with said fluid conduit for controlling fluid flow from said fluid source, through said fluid conduit and to said cells;
an electrolyte level sensor capable of generating signals indicative of an amount of electrolyte in at least one of said cells; and
a controller attached to said battery and in communication with said electrolyte level sensor and said valve system, said controller controlling said valve system to allow fluid to flow to said cells in response to signals from said level sensor indicative of a deficient amount of electrolyte in said cells, and preventing fluid flow to said cells in response to signals from said level sensor indicative of a sufficient amount of electrolyte in said cells.

2. An electric battery according to claim 1, wherein said valve system comprises:
a conduit valve positioned in said fluid conduit to control fluid flow from said fluid source to said cells, said conduit valve being in communication with and under the control of said controller for opening and closing thereof;
a plurality of cell valves, one of said cell valves being positioned in each of said cells for controlling fluid flow from said fluid conduit to each of said cells.

3. An electric battery according to claim 2, wherein each of said cell valves comprises a valve member responsive to a level of fluid in each said cell to effect opening of said cell valve when said amount of fluid is less than a first predetermined amount, and closing of said cell valve when said amount of fluid is greater than a second predetermined amount.

4. An electric battery according to claim 2, wherein said controller comprises a microprocessor.

5. An electric battery according to claim 4, wherein said conduit valve is electrically openable and closable by said microprocessor.

6. An electric battery according to claim 1, wherein said fluid source has a fitting connectable to said fluid conduit through a coupling attached to said battery, said coupling comprising:
a biasing member positioned between said coupling and said fitting for ejecting said fitting away from and out of engagement with said coupling; and
a latch movable between a first position engaging and holding said fitting in engagement with said coupling against said biasing member, and a second position releasing said fitting from engagement with said coupling, said latch being actuated between said first and second positions by said controller.

7. An electric battery according to claim 6, wherein said latch is electrically actuatable between said positions.

8. An electric battery according to claim 6, wherein said latch comprises a sensor adapted to generate signals indicative of engagement and disengagement of said fitting with said coupling, said sensor being in communication with said controller.

9. An electric battery according to claim 1, further comprising a ventilated cover positioned on said battery over said controller and said valve system.

10. An electric battery according to claim 9, wherein said cover is locked to said battery thereby restricting access to said controller and said valve system.

11. An electric battery according to claim 1, further including:
a charging sensor capable of generating a signal indicating when said battery is being charged, said charging sensor being in communication with said controller; and
an air pump in fluid communication with said cells, said air pump being in communication with and controlled by said controller and pumping air into said cells to promote mixing of said fluid therein and thereby prevent acid stratification during charging.

12. An electric battery according to claim 11, wherein said charging sensor comprises a Hall Effect device mounted on said battery for measuring flow of electrical current to said battery indicative of charging.

13. An electric battery according to claim 11, wherein said charging sensor comprises an electrical shunt device mounted on said battery for measuring flow of electrical current to said battery indicative of charging.

14. An electric battery according to claim 11, further comprising an air conduit fixed to said battery and extending to each of said cells, said air conduit providing fluid communication between said air pump and said cells.

15. An electric battery according to claim 11, further comprising a ventilated cover positioned on said battery over said controller, said valve system and said air pump.

16. An electric battery according to claim 15, wherein said cover is locked to said battery thereby restricting access to said controller, said valve system and said air pump.

17. An electric battery having a plurality of aqueous electrolyte cells, said battery comprising:
an air pump fixed to said battery;
an air conduit fixed to said battery and in fluid communication with said air pump, said air conduit extending to each of said cells and providing fluid communication between said air pump and said cells;
a charging sensor attached to said battery and capable of generating signals indicating when said battery is being charged; and
a controller in communication with said charging sensor and said air pump, said controller activating said air pump in response to said signals from said charging sensor indicating that said battery is being charged, said air pump pumping air into said cells to promote mixing of said electrolyte and thereby prevent acid stratification during charging.

18. An electric battery according to claim 17, further comprising a plurality of air pumps in fluid communication with said air conduit, said controller being in communication with said air pumps and activating said air pumps upon charging of said battery, said air pumps pumping air into said cells to promote mixing of said electrolyte and thereby prevent acid stratification during charging.

19. An electric battery according to claim 18, wherein said controller includes:
a pump sensor capable of generating a signal indicating failure of any of said pumps; and
an alarm in communication with said controller, said alarm being responsive to said pump sensor signal and adapted to generate an alarm signal indicative of said failure.

20. An electric battery according to claim 17, further comprising a ventilated cover positioned on said battery over said controller and said air pump.

21. An electric battery according to claim 17, wherein said charging sensor comprises a Hall Effect device mounted on said battery for measuring flow of electrical current to said battery indicative of charging.

22. An electric battery according to claim 17, wherein said charging sensor comprises an electrical shunt device mounted on said battery for measuring flow of electrical current to said battery indicative of charging.

23. An electric battery having an aqueous electrolyte, said battery comprising:
a plurality of first cells holding said electrolyte;
a first air pump;
a first air conduit in fluid communication with said first air pump and extending to said first cells to provide fluid communication between said first air conduit and each of said first cells;
a plurality of second cells holding said electrolyte;
a second air pump;
a second air conduit in fluid communication with said second air pump and extending to said second cells to provide fluid communication between said second air conduit and each of said second cells;
a sensor capable of generating signals indicating when said battery is being charged; and
a controller in communication with said sensor and said first and second air pumps, said controller activating said air pumps in response to said signals from said sensor indicating that said battery is being charged, said air pump pumping air into said first and second cells to promote mixing of said electrolyte and thereby prevent acid stratification during charging.

24. An electric battery according to claim 23, further comprising a bridge conduit providing fluid communication between said first and said second air conduits, said bridge conduit allowing one of said first and second pumps to pump air into both of said first and said second cells during charging of said battery.

25. An electric battery according to claim 23, wherein said controller includes:
a pump sensor capable of generating a signal indicating failure of any of said pumps; and
an alarm in communication with said controller, said alarm being responsive to said pump sensor signal and adapted to generate an alarm signal indicative of said failure.

26. An electric battery according to claim 23, further comprising a ventilated cover positioned on said battery over said controller and said air pumps.

27. A method of mixing electrolyte in cells of an electric battery having a liquid electrolyte to prevent stratification, said method comprising the steps of:
sensing when said battery is being charged; and
pumping air into said electrolyte within said cells during charging using an air pump mounted on said battery in fluid communication with said cells through a conduit fixed to said battery.

28. A method according to claim 27, wherein said pumping step is effected using a plurality of air pumps.

29. A method according to claim 28, further comprising the steps of:
sensing if one of said air pumps fails to operate; and
compensating for a failure of one of said air pumps using other of said air pumps.

30. A method according to claim 29, wherein said compensating step comprises increasing a rate at which said other air pumps pump air over said predetermined rate.

31. A method according to claim 29, wherein said compensating step comprises increasing a duration over which said other pumps pump air over said predetermined duration.

32. A method of replenishing fluid to cells of an electric battery having a liquid electrolyte, said method comprising the steps of:
connecting said battery to a fluid source;
sensing when said electrolyte in said battery is low; and
allowing fluid to flow from said fluid source to said cells through a conduit fixed to said battery.

33. A method according to claim 32, further comprising the steps of:
sensing when said electrolyte in said battery is adequate; and
halting flow of said fluid to said cells.
